(19) United States
(12) Patent Application Publication
(10) Pub. No.: US 2008/0294880 A1
(43) Pub. Date: Nov. 27, 2008

(54) CUSTOMIZATION OF A MICROPROCESSOR AND DATA PROTECTION METHOD

(75) Inventors: Philippe Roquelaure, Bouc-Bel-Air (FR); Frederic Bancel, Lamanon (FR); Nicolas Berard, Trets (FR)

Correspondence Address: STMicroelectronics Inc.;c/o WOLF, GREENFIELD & SACKS, P.C., 600 Atlantic Avenue, BOSTON, MA, 02210-2206, US

(73) Assignee: STMicroelectronics S.A., Montrouge (FR)

(21) Appl. No.: 12/122,742

(22) Filed: May 19, 2008

(30) Foreign Application Priority Data
May 21, 2007 (FR) FR 07/55158

(51) Int. Cl. G06F 9/318

(52) U.S. Cl. 712/226; 712/E09.035

(57) ABSTRACT

An electronic circuit containing a processing unit for executing program instructions, including at least one unit for recognizing at least one first instruction operator in the program and for converting this first operator into another instruction operator, both operators being interpretable by the processing unit. A method for controlling the access to data by such a circuit.

### BACKGROUND OF THE INVENTION

1. Field of the Invention

The present invention generally relates to digital data processing units and, more specifically, to electronic circuits integrating a central processing unit which interprets instructions of programs contained in one or several memories internal or external to this processing unit.

The present invention more specifically applies to integrated circuits having at least one storage element storing controlled-access data.

2. Discussion of the Related Art

In a processing unit, programs are generally stored in a non-volatile memory. When a program manipulates controlled-access data (for example, ciphering keys contained in the integrated circuit) or executes specific functions (for example, a ciphering or watermarking algorithm), the program instructions are capable of accessing controlled-access data or to manipulate said data. This is why it is desired to avoid having an ill-meaning user get to know the program. Indeed, the obtaining of the program or software code by an ill-meaning user may enable him to replay this program on another processing unit in which he is able to monitor the data conveyed by the different buses, to then be able to discover the secrets of the circuit.

This problem is all the more critical as programs require updating and as such updates are performed by downloads generally via networks which are not necessarily secure.

It would be desirable to have a protection mechanism which forbids a program dedicated to a circuit or to a type of circuit to perform its function of access to controlled-access data when executed on another circuit. “Access-controlled data” is used to designate data (instructions, variables, etc.), the access to which or the manipulation of which is desired to be reserved to a circuit or to a group of circuits. These are, for example, data securing keys, sub-programs enabling accessing such keys, etc.

### SUMMARY OF THE INVENTION

The present invention aims at overcoming all or part of the disadvantages linked to the execution of a program by a processing unit capable of providing access to controlled-access data.

An object more specifically is to make ineffective a possible interpretation of programs manipulating controlled-access data.

Another object is to prevent a program intended for a circuit from fulfilling its function if it is executed on another circuit.

Another object is to make the protection mechanism transparent for the user.

To achieve all or part of these objects, as well as others, one embodiment of the present invention provides an electronic circuit containing a processing unit for executing program instructions, comprising at least one unit for recognizing at least one first instruction operator in the program and for converting this first operator into another instruction operator, both operators being interpretable by the processing unit.

According to an embodiment, the unit is a memory plane containing, as an address, the first operator and, as corresponding data, the other operator.

According to an embodiment, the unit is activable depending on a memory from which the instructions to be processed originate.

The present invention also provides a method for controlling the access to data in an electronic circuit containing a program execution processing unit, in which:

first instruction operators contained in a program to be executed are, on loading thereof for execution, compared with at least one first operator; and

in case of an identity, the first operator is replaced with the second one providing access to said data.

According to an embodiment, each first operator and its associated second operator result in an identical execution time.

The foregoing and other objects, features, and advantages of the present invention will be discussed in detail in the following non-limiting description of specific embodiments in connection with the accompanying drawings.

### BRIEF DESCRIPTION OF THE DRAWINGS

FIG. 1 shows a smart card of the type to which the present invention applies as an example;

FIG. 2 very schematically shows a receiver of radio broadcast signals of the type to which the present invention applies as an example;

FIG. 3 is a block diagram of an example of an electronic circuit architecture comprising a digital processing unit according to an embodiment;

FIG. 4 is a functional block diagram partially illustrating an embodiment of a redirection unit of the circuit of FIG. 3;

FIGS. 5A and 5B illustrate the operation of the embodiment of FIG. 4; and

FIG. 6 is a partial block diagram of another embodiment of a processing unit.

### DETAILED DESCRIPTION

The same elements have been designated with the same reference numerals in the different drawings.

For clarity, only those steps and elements which are useful to the understanding of the present invention have been shown and will be described. In particular, the interpretation of the instructions of a program by the processing unit has not been described in detail, the present invention being compatible with conventional interpretations and exploitations of program instructions. Further, the mechanisms for storing program instructions in a memory have not been detailed either, the present invention being here again compatible with conventional techniques.

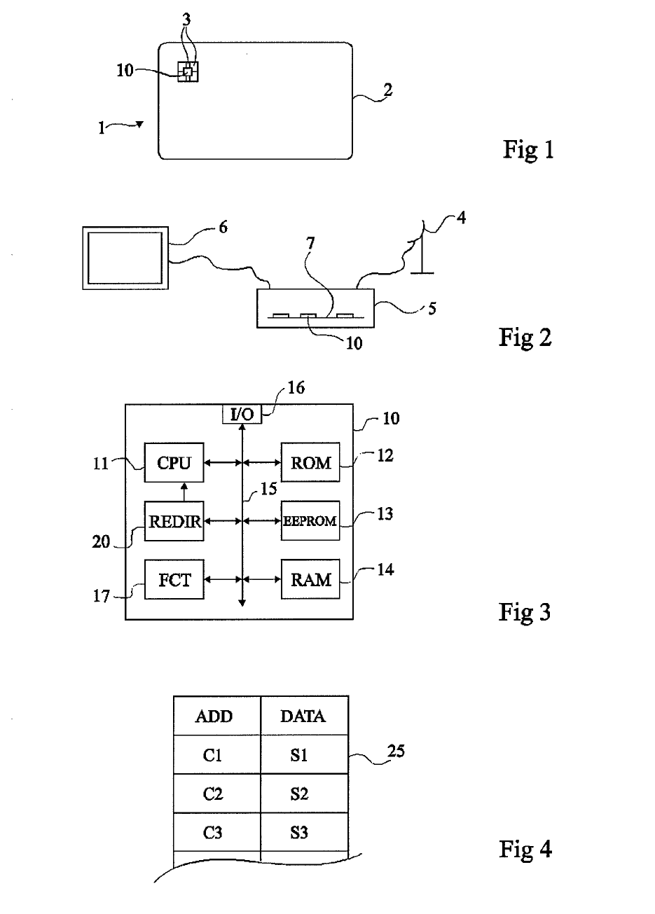

FIG. 1 very schematically shows a smart card 1 of the type to which the present invention applies as an example. Such a card is, for example, formed of a support 2 made of plastic matter in or on which is placed an electronic circuit chip 10 capable of communicating with the outside by means of contacts 3 or by means of contactless transceiver elements (not shown). Circuit 10 of the card contains a processing unit as well as controlled-access data.

FIG. 2 shows another example of application of the present invention to controlled-access broadcasting systems. In this example, an antenna 4 receives signals originating from a satellite (not shown) and transmits them to a decoder 5 for display on a television set 6. Decoder 5 comprises one or several electronic cards 7 provided with one or several circuits 10 for processing received digital data. This processing comprises a decoding by means of one or several secret quantities (cryptographic keys) owned by decoder 5. These keys are contained in memories associated with electronic circuit 10 or on an external element, for example, a smart card introduced into decoder 5. In this example, it is considered that circuit 10 is capable of executing a program enabling access to such controlled-access data.

FIG. 3 is a block diagram of an embodiment of an electronic circuit 10. This circuit comprises a central processing unit 11 (CPU) capable of executing programs contained in one or several memories. In this example, circuit 10 comprises a non-reprogrammable non-volatile memory 12 (ROM), a reprogrammable non-volatile memory 13 (EEPROM), and a RAM 14. One or several data, control, and address buses 15 are used as a support for the communication between the different components of circuit 10 and with an input/output interface 16 (I/O) of communication with or without contact with the outside. Most often, circuit 10 comprises other functions (block 17, FCT) depending on the application. These are for example dedicated cryptographic calculation cells for implementing ciphering algorithms.

According to this embodiment, circuit 10 comprises a unit 20 for redirecting some instructions towards other predefined instructions. The object of this unit is to transform determined instruction operators in the programs into other operators also interpretable by the processing unit and capable of accessing the controlled-access data. Unit 20 provides, for example, the instructions directly to processing unit 11 over a specific link or uses buses 15 again. According to another embodiment which will be described hereafter in relation with FIG. 6, unit 20 is interposed between the instruction bus of the processing unit and the buses accessing the memories external to this unit.

The redirection of program instructions is only performed if the circuit in which the program is executed has a properly-configured unit 20. Accordingly, the same program executed by a circuit for which it is not intended will not access the data to be protected.

Conversion unit 20 may be activated by a code, by a specific instruction, by an address decoding, by writing into an activation register bit, etc. According to another implementation mode, this unit will be permanently activated.

FIG. 4 is a functional block diagram illustrating an embodiment, in an authorized circuit, for example, a secure platform to which a program is dedicated. According to this embodiment, unit 20 comprises a memory plane 25 where each address corresponds to the code of a specific instruction C1, C2, C3, etc. The data contained at the address form another operator, respectively S1, S2, S3, etc. corresponding to a secure operator. For each instruction operator, unit 20, if activated, addresses its memory plane 25 with the operator code. If the address provides data, unit 20 replaces the operator with that present as data at this address in memory plane 25. In the opposite case, the code is not redirected. Instructions C1, C2, etc. can be considered as unsecure instructions, that is, instructions executable by any circuit while instructions S1, S2, etc. can be considered as secure instructions since they are only interpreted if the software code is executed by a processing unit associated with a redirection unit 20.

According to another example, the instruction redirection is performed by a logic decoding.

Conversely to a deciphering of a ciphered software code, no deciphering key is used in this process, which is a mere transformation of one executable instruction into another when the program is executed on the authorized platform.

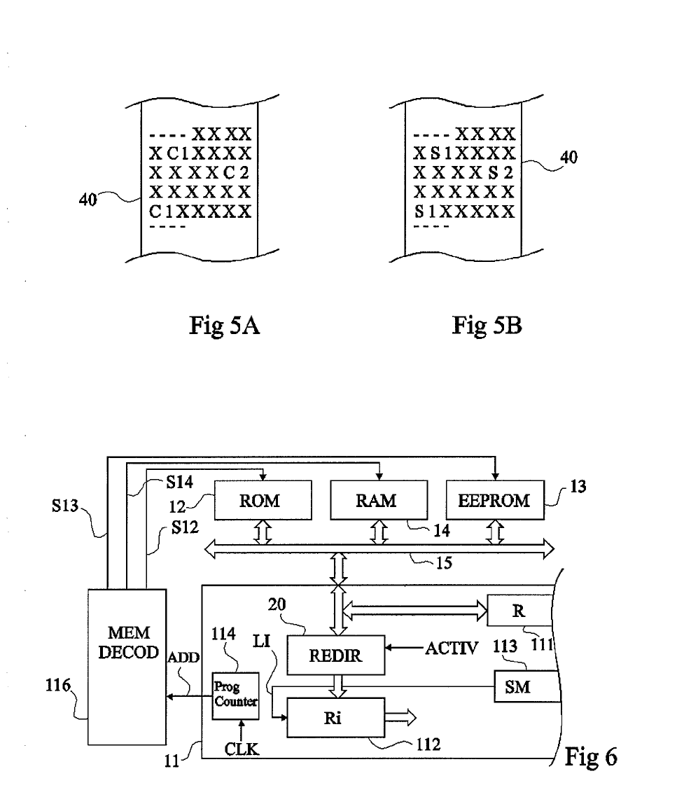

FIG. 5A and 5B illustrate this functionality by showing two examples of a program 40 executed by a processing unit having no unit 20 (FIG. 5A) and by an authorized processing unit, that is, which is provided with an instruction redirection unit 20.

In the example of FIGS. 5A and 5B, two instructions C1 and C2 are used, for example, at the beginning of sub-programs manipulating controlled-access data. The number and the frequency of occurrence of the redirected instructions depend on the application.

Unsecure instructions C1 and C2 as well as secure instructions S1 and S2 are all interpretable by the processing unit so that in case of a deactivation of unit 20 or of an execution by an unauthorized circuit, the software code still executes a function by decoding of instructions C1 and C2 without allowing this to provide access to the protected data. In case of an execution on a non-secure or unauthorized platform, the user thus does not notice the absence of access to the protected data since a function is effectively executed by the program.

For example, on design of the program and more specifically of sub-programs manipulating controlled-access data, the programmer determines the critical instructions which, when executed in another way, will not provide the expected functionality but will not block the system either. It then replaces, in the software code, each occurrence of these instructions (for example, S1 and S2) with risk-free instructions (for example C1 and C2). It then configures the system and especially unit 20 (for example, it fills memory plane 25) so that instructions C1 and C2 are respectively redirected towards instructions S1 and S2.

According to another example of embodiment, the software code is modified on compilation thereof or on installation thereof in the central unit by usual deciphering systems so that it directly implements in the software code the redirected instructions.

According to a preferred embodiment, the instructions redirected by unit 20 are set by hardware means (in a non-volatile memory set on manufacturing) in the integrated circuit. As a variation, the operation codes redirected by unit 20 are programmable in a secure operating mode of the circuit.

Unit 20 may also be used to activate or deactivate a specific circuit function due to beginning and end instructions of code portions intended for a controlled execution. It may be, for example, the activation and deactivation of a secure mode operation of an integrated circuit. It may also be, according to another example, an activation or not of a ciphering algorithm.

FIG. 6 is a partial block diagram of another embodiment of a processing unit 11 (CPU). In this example, ROM 12, non-volatile reprogrammable memory 13, and RAM 14 of the example of FIG. 3, which communicate via buses 15, are present again. Some memories may be external to the circuit integrating the processing unit. Other functions of the integrated circuit, not shown in FIG. 4, may of course be present.

Like any program processing unit, an instruction, for its execution, is transferred into registers contained by unit 11. Each instruction comprises an operator and most often one or several operands or arguments (for example, addresses, variables, etc.). An instruction register 112 (RI) is intended to receive the instruction operators and one or several registers 111 (R) are intended to receive the arguments (addresses) or operands (values) associated with the operators. The operation codes (OpCodes) forming the arguments or operands may originate from a different memory than those containing the operation code representing the operator. The loading of the instructions from any of memories 12, 13, or 14 is performed under control of a program counter 114 (Prog Counter) which provides an address ADD to a memory decoder 116 (MEM DECOD) in charge of selecting that of the memories which contains the instruction requested by the processing unit. Decoder 116 is either integrated to processing unit 11, or an element separate from this unit. It provides signals S12, S13, and S14 to respective memories 12, 13, and 14. The signals for example are individual signals intended for the different memories to select the memory which must provide the instruction over bus 15. According to another example, not shown, all memories receive the same signal, the content of which differs according to the addressed memory, the memories then comprising means for interpreting this single signal.

The different elements of processing unit 11 are synchronized by a clock signal CLK (for simplification, only illustrated as provided to program counter 114). Instruction register 112 receives a load instruction signal LI provided by a sequencer or state machine 113 (SM) of unit 11 when an instruction is ready on bus 15 to be loaded. The operation codes of the instruction are distributed in unit 11 between instruction register 112 for the operator and registers 111 for the arguments or operands. Signal LI is only provided for the instruction operators and not for their arguments or operands.

According to the embodiment shown in FIG. 6, the operator of an instruction coming from bus 15 is loaded into instruction register 112 after having passed through possible redirection unit 20. Accordingly, the operator is either directly loaded into register 112, or transformed into another operator contained in unit 20 and corresponding to the protected instruction. Preferably, unit 20 receives an activation signal (ACTIV) which, when in an inactive state, does not cause the conversion of operators. The activation signal comes either from the actual processing unit, or from the memory decoder according to the addresses sent by the program counter. Such a variation for example enables only activating the redirection function when the program comes from a determined memory (for example, a RAM or the EEPROM reprogrammable memory).

The code sequence itself determines whether the instructions read from the memories must be redirected or not so that the mechanism is transparent for the operator.

According to an embodiment, unit 20 is formed of a finite state machine containing the codes of the instructions to be detected and of the redirected instructions.

An advantage is that any processing unit or microprocessor embarked in a secure platform becomes customized for a given software code on a given product. The security of the software code is thereby increased since only the original product can run the sub-programs such as they have been written, and the same software code transferred onto another hardware platform will not operate in the same way and will thus not fulfill the same function.

Another advantage is that this mechanism is transparent for the user, in particular by ascertaining to use unsecure instructions which result in the execution of functions using no controlled-access data.

Preferably, the selection of these instructions will be such that their execution duration is identical to that of the secret instructions, to mask the operation even more.

Specific embodiments of the present invention have been described. Various alterations and modifications will occur to those skilled in the art. In particular, the practical implementation of the present invention (especially, the selection of the instructions to be detected) and its adaptation to a given circuit is within the abilities of those skilled in the art based on the functional indications given hereabove. Further, although the present invention has been described in relation with an example in which the programs are contained in memories integrated with a processing unit, it also applies to the case where the programs are contained in external memories. Finally, the redirection performed by the present invention is compatible with any other protection of the programs (for example, their ciphered storage).

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. An electronic circuit containing a processing unit for executing program instructions, comprising at least one unit for recognizing at least one first instruction operator in the program and for converting this first operator into another instruction operator, both operators being interpretable by the processing unit memory plane containing, as an address, the first operator and, as corresponding data, the other operator.

2. The circuit of claim 1, wherein the unit is activable according to a memory from which the instructions to be processed originate.

3. A method for controlling the access to data in an electronic circuit containing a program execution processing unit, wherein:
first instruction operators contained in a program to be executed are, on loading thereof for execution, compared with at least one first operator; and
in case of an identity, the first operator is replaced with a third operator providing access to said data, the first operator corresponding to an address in a memory plane and the corresponding addressed data being the third operator.

4. The method of claim 3, wherein each first operator and its associated second operator result in an identical execution time.
